(19) United States
(12) Patent Application Publication
(10) Pub. No.: US 2014/0099039 A1
(43) Pub. Date: Apr. 10, 2014

(54) IMAGE PROCESSING DEVICE, IMAGE PROCESSING METHOD, AND IMAGE PROCESSING SYSTEM

(71) Applicant: SONY CORPORATION, Tokyo (JP)

(72) Inventors: Masakazu KOUNO, Tokyo (JP); Ryohei OKADA, Chiba (JP); Yuji FUJIMOTO, Kanagawa (JP); Yuichi ARAKI, Tokyo (JP); Yuji ANDO, Kanagawa (JP); Hiroyuki YASUDA, Saitama (JP)

(73) Assignee: SONY CORPORATION, Tokyo (JP)

(21) Appl. No.: 13/966,346

(22) Filed: Aug. 14, 2013

(30) Foreign Application Priority Data
Oct. 5, 2012 (JP) 2012223048

(51) Int. Cl. G06T 9/00

(52) U.S. Cl. CPC G06T 9/00
USPC 382/232

(57) ABSTRACT

There is provided an image processing device including a converter configured to obtain, prior to performing an encoding process, image drawing information of an image capable of using upon encoding and to convert the obtained image drawing information into a parameter for encoding, and an encoding processor configured to perform the encoding process by changing contents of the encoding process according to the parameter for encoding converted by the converter.

### BACKGROUND

The present disclosure relates to an image processing device, an image processing method, and an image processing system.

With the development of multifunctional mobile phones (smart phones) or tablet terminals, these many terminals are equipped with a hardware decoder that decodes moving images. For this reason, a server is provided with applications which allow a user to easily operate still or moving images (both images are referred to collectively as content), and content is encoded by the server in real time and the encoded content is distributed to a client, according to a user's operation in the client. This makes it possible for the user to enjoy content in the client without any stress.

However, an image displayed on a client by the user's operation in the client is changed every time, and thus it is necessary to perform an encoding process for the above-described applications each time when content is distributed to a client. The encoding process causes a load to be applied to a server, thus it is necessary to reduce throughput of the encoding process without degrading the quality of content.

### SUMMARY

When content is distributed from a server to a client, in order to reduce load on the server and maintain a high quality of service, it is necessary to simultaneously achieve low latency, low cost, improvement of robustness for fluctuation in a network bandwidth, and retention of image quality acceptable to a service. However, it is difficult to achieve these things with an encoder according to the related art.

For example, Japanese Unexamined Patent Application Publication No. 2005-295215 discloses a technique in which a code amount is reduced by detecting a still region and performing a filtering process on the still region, and an image quality is improved by increasing a code amount of the moving region, thereby encoding a moving image with a smaller code amount and increasing the transmission efficiency. However, in the technique disclosed in Japanese Unexamined Patent Application Publication No. 2005-295215, it is necessary to perform an inverse quantization on the quantized code to detect a still region, and to further reduce throughput when a server encodes content in real time.

Therefore, in accordance with an embodiment of the present disclosure, there is provided a novel and improved image processing device, image processing method, and image processing system, capable of obtaining image drawing information regarding the movement or position change of an image which can be used in encoding prior to encoding, and capable of reducing throughput of an encoding process without degrading a quality of content by performing an encoding process using the obtained image drawing information.

According to an embodiment of the present disclosure, there is provided an image processing device including a converter configured to obtain, prior to performing an encoding process, image drawing information of an image capable of using upon encoding and to convert the obtained image drawing information into a parameter for encoding, and an encoding processor configured to perform the encoding process by changing contents of the encoding process according to the parameter for encoding converted by the converter.

According to an embodiment of the present disclosure, there is provided an image processing method including obtaining, prior to performing an encoding process, image drawing information of an image capable of using upon encoding and converting the obtained image drawing information into a parameter for encoding; and performing the encoding process by changing contents of the encoding process according to the parameter for encoding converted in the step of converting.

According to an embodiment of the present disclosure, there is provided an image processing system including a server device configured to encode an image and distribute the encoded image over a network, and a terminal device configured to display the image distributed from the server device. The server device includes, a converter configured to obtain, prior to performing an encoding process, image drawing information of an image capable of using upon encoding and to convert the obtained image drawing information into a parameter for encoding, and an encoding processor configured to perform the encoding process by changing contents of the encoding process according to the parameter for encoding converted by the converter.

As described above, in accordance with embodiments of the present disclosure, there can be provided a novel and improved image processing device, image processing method, and image processing system, capable of obtaining image drawing information regarding the movement or position change of an image which can be used in encoding prior to encoding, and capable of reducing throughput of an encoding process without degrading the quality of content by performing an encoding process using the obtained image drawing information.

### BRIEF DESCRIPTION OF THE DRAWINGS

FIG. 1 is a schematic diagram illustrating an overall configuration of a streaming system in accordance with an embodiment of the present disclosure;

FIG. 2 is a diagram illustrating an example of an information flow in a streaming system in accordance with an embodiment of the present disclosure;

FIG. 3 is a schematic diagram illustrating functional configurations of a client and a server in a streaming system in accordance with an embodiment of the present disclosure;

FIG. 4 is a schematic diagram illustrating a functional configuration of a stream processor in accordance with an embodiment of the present disclosure;

FIG. 5 is an explanatory diagram illustrating an exemplary functional configuration of a video encoder 325a included in a server 300 in accordance with an embodiment of the present disclosure;

FIG. 6 is an explanatory diagram illustrating an exemplary functional configuration of an encoding processor 372 in accordance with an embodiment of the present disclosure;

FIG. 7 is an explanatory diagram illustrating a definition of terms used for explaining an operation of the video encoder 325a in accordance with an embodiment of the present disclosure;

FIG. 8 is an explanatory diagram illustrating a definition of terms used for explaining an operation of the video encoder 325a in accordance with an embodiment of the present disclosure;

FIG. 9 is a flow chart illustrating an exemplary operation of the video encoder 325a in accordance with an embodiment of the present disclosure;

FIG. 10 is an explanatory diagram used for explaining data useful for an encoding process in the encoding processor 372;

FIG. 11 is an explanatory diagram illustrating a modified example of the video encoder 325a in accordance with an embodiment of the present disclosure; and

FIG. 12 is an explanatory diagram illustrating an exemplary hardware configuration of an information processing apparatus 900.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

<1. Embodiment of the Present Disclosure>
[Exemplary Overall Configuration of System]
[Exemplary Configuration of Encoder]
[Exemplary Operation of Encoder]
[Modified Example of Encoder]

<2. Conclusion>

### 1. EMBODIMENT OF THE PRESENT DISCLOSURE

### Exemplary Overall Configuration of System

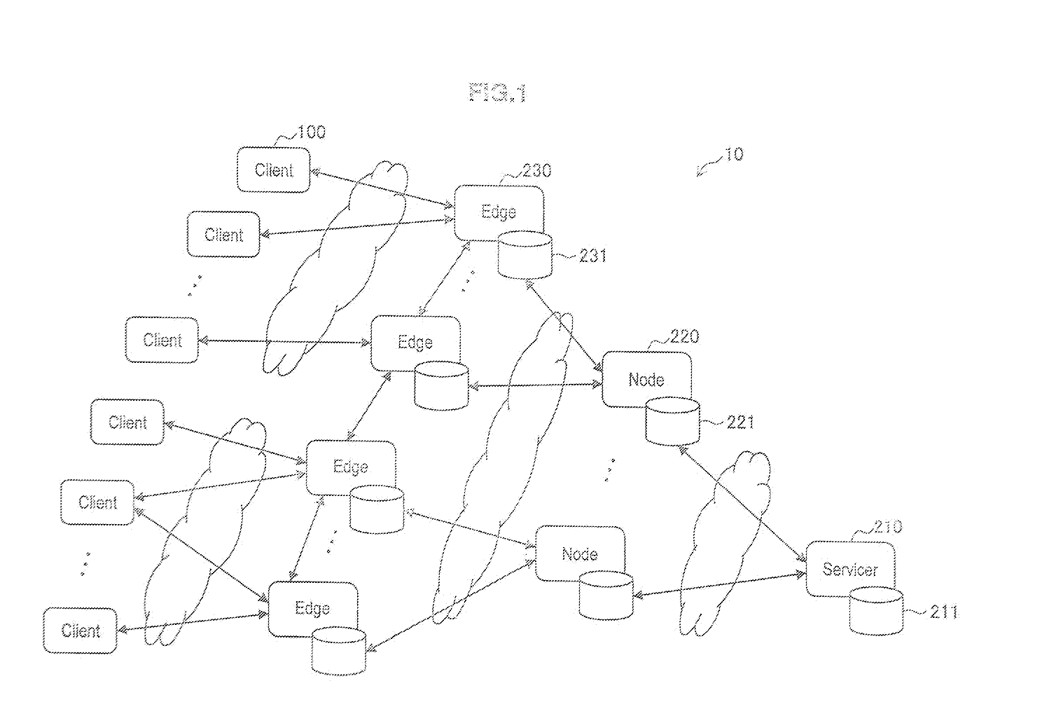

At first, the overall configuration of a streaming system to which an embodiment of the present disclosure is applied will be described. FIG. 1 is a schematic diagram illustrating an overall configuration of a streaming system with accordance with an embodiment of the present disclosure. A streaming system 10 includes a client 100 and a server (servicer 210, node 220, and edge 230) which is configured to distribute streaming contents to the client 100. The client 100 and each server are connected to each other through various types of wired or wireless networks. The servicer 210 holds original content 211. The node 220 is the node that constitutes a contents delivery network (CDN) and holds content 221 obtained by copying the original content held by the servicer 210. The edge 230 performs a direct interaction with the client 110 and appropriately processes the content on request, and provides the processed content to the client 100. In this case, the edge 230 obtains the content held by the node 220 as a content cache 231 and provides the content to the client 100 on request from the client 100.

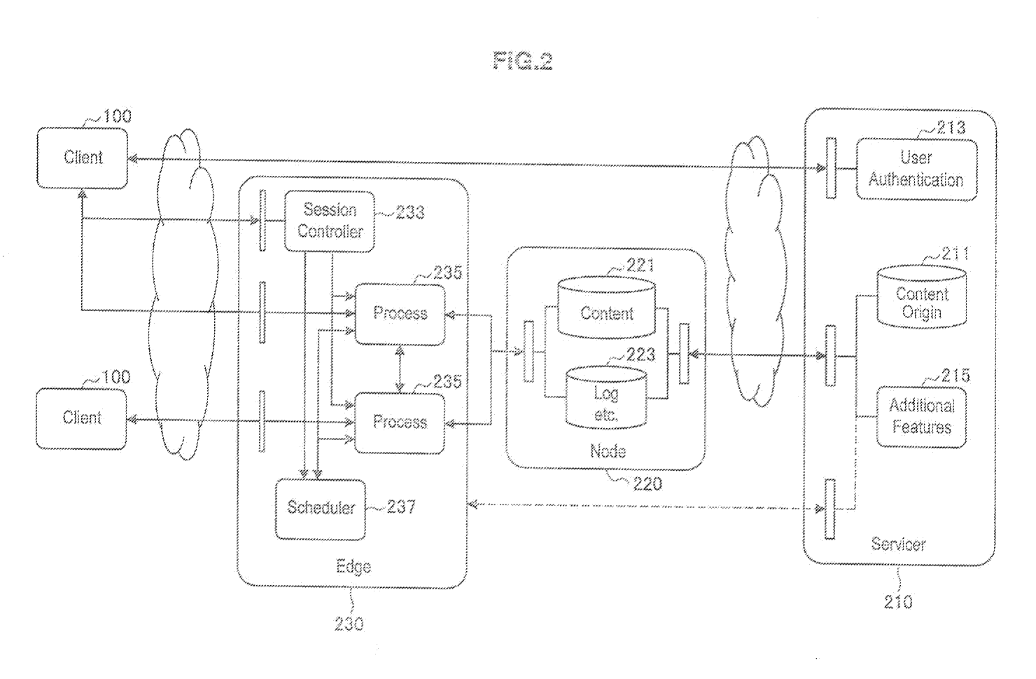

FIG. 2 is a diagram illustrating an example of an information flow in the streaming system in accordance with an embodiment of the present disclosure. The client 100 accesses a user authentication module 213 of the servicer 210 to log into a service prior to distribution of content. When the client 100 is successfully logged into the service, the client 100 accesses a session controller 233 of the edge 230 and requests the session controller 233 to start a process for the client 100. In response to this request, the session controller 233 starts up a process 235. The process 235 is to be started up for each client 100 as illustrated and executes a process for distributing content in response to a request from the client 100. Thus, when the edge 230 provides a service to a plurality of clients 100, a plurality of processes 235 may be started up in the edge 230. Each of the processes 235 is scheduled by a scheduler 237. The scheduler 237 is controlled by the session controller 233.

On the other hand, the original content 211 held by the servicer 210 is previously copied by the node 220 and is held in the node 220 as the content 221. In the process 235 that is activated in the edge 230, the content 221 held in node 220 is obtained as a cache in response to the request from the client 100, the content 221 is appropriately processed, and the processed content is provided to the client 100. In this case, a log of how the content is provided in response to what kind of requests from a client 100 may be recorded in the process 235. This log and other information may be provided to the node 220 by the process 235 and may be held as information 223 in the node 220. The information 223 that contains the log. etc. may be used, for example, by additional features of the servicer 210.

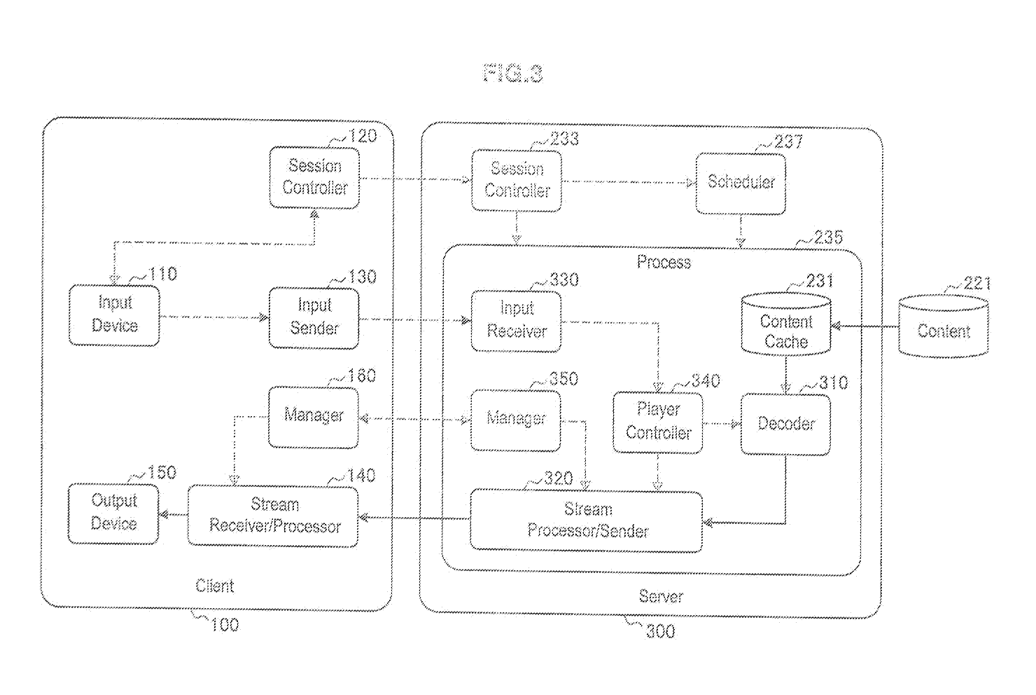

FIG. 3 is a schematic diagram illustrating a functional configuration of the client and server in the streaming system in accordance with an embodiment of the present disclosure. A server 300 functions as the edge 230 in the streaming system described above with reference to FIGS. 1 and 2. In FIG. 3, a solid line indicates the flow of streaming content to be distributed to a client 100, and a broken line indicates the flow of control information related to the reproduction of the streaming content.

The client 100 is the device that provides streaming content to a user, and may be various types of personal computers, tablet terminals, mobile phones (including smart phones), media players, game consoles, or the like. On the other hand, the server 300 may be a single server device, or may be a collection of functions that are implemented by cooperation of a plurality of server devices connected to each other through various wired or wireless networks. The client 100 and each server device constituting the server 300 may be implemented, for example, using the hardware configuration of an information processing apparatus to be described later. The components, except for a device such as an input device, an output device, and content data among the structural elements illustrated in FIG. 3, may be implemented in software by a processor such as a central processing unit (CPU).

In the client 100, an input device 110 obtains a user's operation input. The input device 110 obtains an operation input related to the outside of content such as login to a service or selection of content and an operation input related to the inside of content such as still/moving image switching, image zoom in/out, or sound quality switching of audio. The operation input related to the outside of content is processed by a session controller 120. The session controller 120 may send input information related to the login to the servicer 210 and may send a request to start a process to the server 300 after login. On the other hand, the operation input related 15 to the inside of content is sent from an input sender 130 to the server 300.

In the server 300, in response to the request to start a process from the client 100, the session controller 233 starts up the process 235. The process 235 obtains the content 221 from the node 220, the content 221 being specified by a content selection operation obtained by the input device 110 of the client 100, and holds the obtained content as a content cache 231. The content cache 231 is the encoded data and is decoded by a decoder 310 in the server 300. The decoded content data is processed in a stream processor/sender 320.

Here, an operation input related to the inside of content obtained by the client 100 is received by an input receiver 330 and is provided to a player controller 340. The player controller 340 controls the decoder 310 or the stream processor/sender 320 in response to the operation input. The stream processor/sender 320 renders video and audio from content data according to the control of the player controller 340. Furthermore, the stream processor/sender 320 encodes the rendered video or audio and sends it to the client 100. In the present embodiment, the content includes video and audio, but in other embodiments, the content may include either one of video and audio.

The encoded data sent to the client 100 is decoded by a stream receiver/processor 140 and is rendered as video or audio, and then is outputted from an output device 150 to a user. The stream processor/sender 320 of the server side is managed by a manager 350, and the stream receiver/processor 140 of the client side is managed by a manager 160. The sever-side manager 350 and the client-side manger 160 cooperate with each other by exchanging information as necessary.

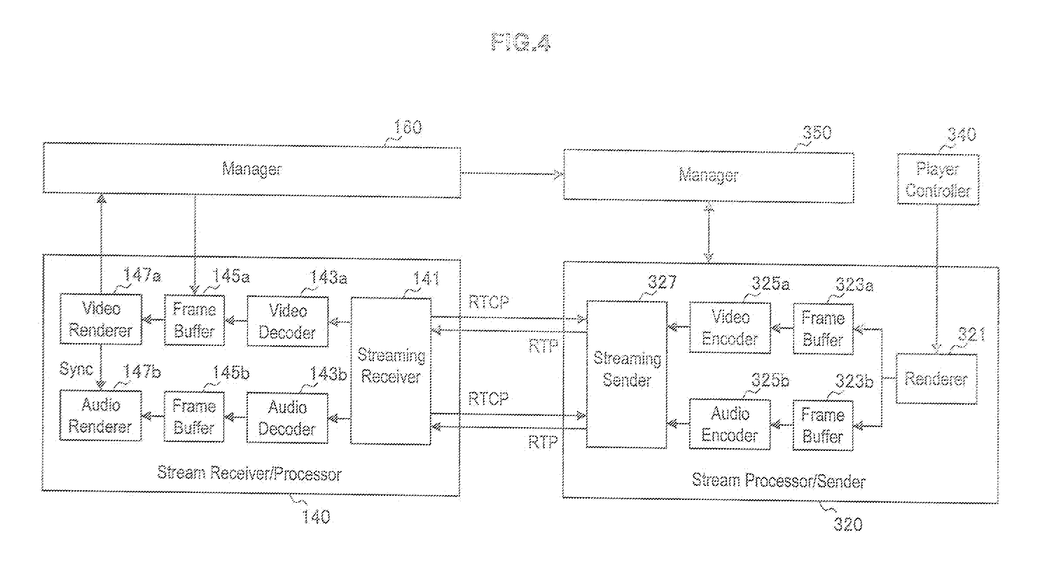

FIG. 4 is a schematic diagram illustrating a functional configuration of a streaming processing unit in accordance with an embodiment of the present disclosure. In FIG. 4, functional configurations of the stream receiver/processor 140 of the client 100 and the stream processor/sender 320 of the server 300 are illustrated.

(Client Side)

The stream receiver/processor 140 includes a stream receiver 141, a decoder 143, a frame buffer 145, and a renderer 147. The stream receiver 141 receives data from a stream sender 327 of the server side according to a predetermined protocol. In the illustrated example, a real-time transport protocol (RTP) is used. In this case, the stream receiver 141 provides the received data to the decoder 143. In addition, the stream receiver 141 detects the communication state such as the delay of data, and reports the detected communication state to the stream sender 327 using an RTP control protocol (RTCP).

Meanwhile, the decoder 143 decodes data provided from the stream receiver to obtain video or audio data. The decoder 143 includes a video decoder 143a that processes video data and an audio decoder 143b that processes audio data. In the stream receiver/processor 140, there may be provided with a plurality of types of each of the video decoder 143a and the audio decoder 143b, which may be selectively used depending on the format of video data or audio data to be processed. In the following description, any one or both of the video decoder 143a and the audio decoder 143b may be referred to as simply the decoder 143 (when referring to either one of them, whether data to be processed by the one is video or audio will be specified).

The video and audio data obtained by the decoder 143 is temporarily stored in the frame buffer 145 on a frame-by-frame basis. The frame buffer 145 includes a frame buffer 145a that stores video data and a frame buffer 145b that stores audio data. The frame buffer 145 inputs video or audio data in each frame to the renderer 147 at a predetermined timing under the control of the manager 160.

The renderer 147 includes a video renderer 147a and an audio renderer 147b. The video renderer 147a renders video data and provides the rendered data to an output device such as a display. The audio renderer 147b renders audio data and provides the rendered data to an output device such as a loudspeaker. The video renderer 147a and the audio renderer 147b respectively synchronize frames of video and audio being outputted. In addition, the renderer 147 reports an ID of the outputted frame, the time when the output is performed, or the like to the manager 160. In the following description, any one or both of the video renderer 147a and the audio renderer 147b may be referred to as simply the renderer 147 (when referring to either one of them, whether data to be processed by the one is video or audio will be specified).

(Server Side)

The stream processor/sender 320 includes a renderer 321, a frame buffer 323, an encoder 325, and a stream sender 327. The renderer 321 uses the content data decoded by the decoder 310 as a source material and renders video data and audio data according to the control by the player controller 340 based on the user's operation input. Here, the frame for video and audio data is defined.

The frame buffer 323 temporarily stores the video and audio data rendered by the renderer 321 on a frame-by-frame basis. The frame buffer 323 includes a frame buffer 323a configured to store video data and a frame buffer 323b configured to stores audio data. The encoder 325 sequentially encodes the video and audio data stored in the frame buffer 323.

The encoder 325 includes a video encoder 325a configured to encode video data and an audio encoder 325b configured to encode audio data. There may be provided with a plurality of types of each of the video encoder 325a and the audio encoder 325b, which may be selectively used depending on the types of the video decoder 143a and the audio decoder 143b that can be used by the client 100 or the characteristics of the video or audio data to be processed. The streaming sender 327 transmits the encoded video and audio data to the client 100.

With the configuration of the streaming system in accordance with the embodiment of the present disclosure as described above, in the server that functions as an edge, it is possible to render video or audio in response to a user's operation input and distribute the rendered video or audio to the client in real time. Thus, it is possible to provide applications by the streaming method while maintaining the responsiveness for a user's operation input. Such applications may include an application in which images are freely zoomed in/out or moved as disclosed in, for example, Japanese Unexamined Patent Application Publication No. 2010-117828 or various applications such as browsing of a large-sized image or video, on-line games, simulation viewers.

In the above description, an exemplary overall configuration of the streaming system, an exemplary information flow, exemplary functional configurations of the client and server, and an exemplary functional configuration of the streaming processor in accordance with an embodiment of the present disclosure have been described with reference to FIGS. 1 to 4. In the following, an exemplary functional configuration of an encoder in accordance with an embodiment of the present disclosure will be described in detail.

### Exemplary Configuration of Encoder

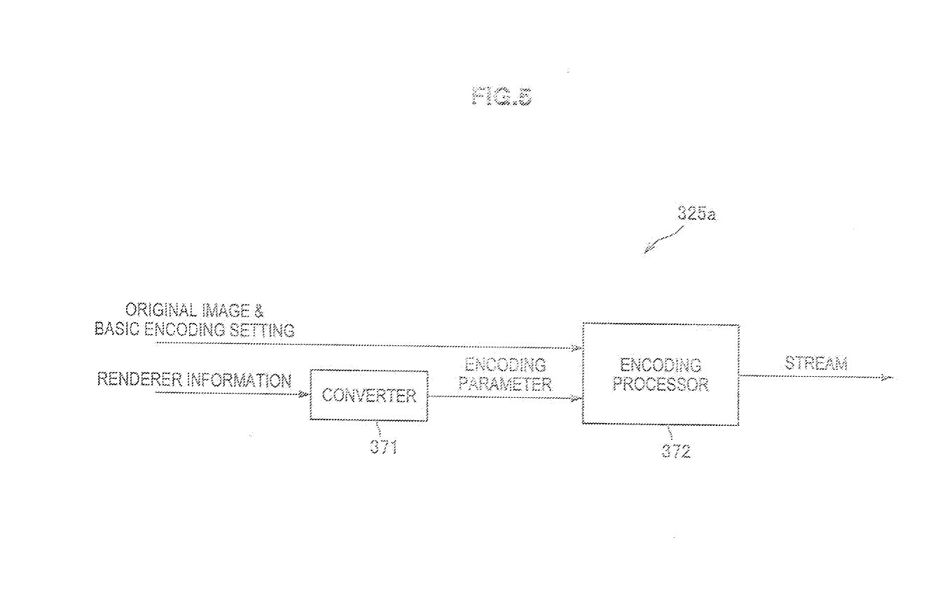

FIG. 5 is an explanatory diagram illustrating an exemplary functional configuration of the encoder 325, in particular the video encoder 325a, which is included in the server 300 according to an embodiment of the present disclosure. An exemplary functional configuration of the video encoder 325a included in the server 300 according to an embodiment of the present disclosure is now described with reference to FIG. 5.

As illustrated in FIG. 5, the video encoder 325a included in the server 300 according to an embodiment of the present disclosure is configured to include a converter 371 and an encoding processor 372.

The converter 371 converts renderer information transmitted from the renderer 321 through the frame buffer 323 into a parameter (encoding parameter) to be used for an encoding process in the encoding processor 372 in a subsequent stage. In this regard, the renderer information transmitted from the renderer 321 contains data useful for the encoding process in the encoding processor 372. In other words, when an authoring or drawing process is performed, the renderer 321 generates information that can be used by the video encoder 325a and outputs the information to the video encoder 325a.

The data useful for the encoding process in the encoding processor 372, for example, may be data that allows the burden of an encoding process to be performed by the encoding processor 372 to be mitigated. The converter 371 converts an amount of movement of an image drawing area for each frame into information regarding a motion vector or converts the contents of an image drawn in an image drawing area for each frame into information regarding a bit rate. In addition, the converter 371 can determine whether there is a process that can be skipped in the encoding process, and the determination is based on the information transmitted from the renderer 321.

The encoding processor 372 performs an encoding process on the video data transmitted from the renderer 321 through the frame buffer 323 using the encoding parameter outputted from the converter 371, and outputs the encoded data as a stream. The encoding process 372 is supplied with encoding setting (basic encoding setting) information from the renderer 321, in addition to an original image of video data. The encoding processor 372 performs the encoding process on the video data transmitted from the renderer 321 based on the basic encoding setting being supplied.

In this regard, the encoding processor 372 allows a burden of the encoding process to be mitigated by using the encoding parameter outputted from the converter 371. For example, the converter 371 converts an amount of movement of an image drawing area for each frame into information regarding a motion vector, and thereby the encoding processor 372 may not calculate a motion vector that becomes the cause of heavy processing. Furthermore, for example, the converter 371 converts the contents of an image drawn in an image drawing area for each frame into information regarding a bit rate. This allows the encoding processor 372 to allocate a higher bit rate for a video having a relatively larger motion or conspicuous text and to allocate a lower bit rate for a video having a relatively smaller motion.

The video encoder 325a included in the server 300 in accordance with an embodiment of the present disclosure converts the renderer information into data (encoding parameter) useful for an encoding process prior to being subjected to the encoding process, thereby reducing throughput of the encoding process without degrading the quality of content.

In the above, there has been described an exemplary functional configuration of the video encoder 325a included in the server 300 in accordance with an embodiment of the present disclosure with reference to FIG. 5. An exemplary functional configuration of the encoding processor 372 in accordance with an embodiment of the present disclosure illustrated in FIG. 5 will now be described.

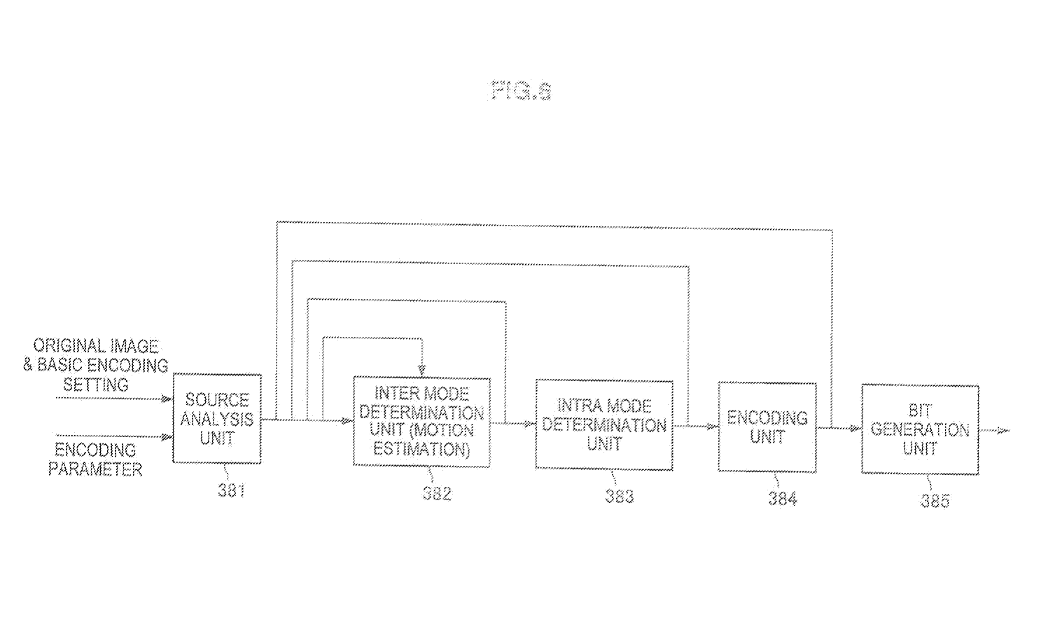

FIG. 6 is an explanatory diagram illustrating an exemplary functional configuration of the encoding processor 372 in accordance with an embodiment of the present disclosure. An exemplary functional configuration of the encoding processor 372 in accordance with an embodiment of the present disclosure will now be described with reference to FIG. 6.

As illustrated in FIG. 6, the encoding processor 372 in accordance with an embodiment of the present disclosure is configured to include a source analysis unit 381, an inter mode determination unit 382, an intra mode determination unit 383, an encoding unit 384, and a bit generation unit 385.

The source analysis unit 381 analyzes video data by using the video data transmitted from the renderer 321 through the frame buffer 323 and the encoding parameter supplied from the converter 371, and determines an encoding mode. The definition of an encoding mode in accordance with the present embodiment will be described in detail later. The source analysis unit 381 performs, in addition to the encoding mode determination, a rate control using an encoding parameter supplied from the converter 371.

The inter mode determination unit 382 determines whether inter-coding (inter-frame prediction) using the preceding and following frames is performed. Thus, the inter mode determination unit 382 performs motion estimation (ME) for inter-coding. The intra mode determination unit 383 determines whether intra-coding is performed within a single frame.

The encoding unit 384 performs an encoding process on video data depending on inter-coding or intra-coding. The encoding unit 384 performs discrete cosine transform (DCT), quantization, entropy coding, or the like on video data. The bit generation unit 385 generates a bit stream to be outputted to the client 100 as a stream.

The encoding processor 372 in accordance with an embodiment of the present disclosure shown in FIG. 6 can determine which block is to be performed, which block is to be skipped, or which block is to be simplified, according to an analysis result obtained from the source analysis unit 381. A specific process of the encoding processor 372 will be described later.

In the exemplary functional configuration shown in FIGS. 5 and 6, the converter 371 outputting the encoding parameter and the source analysis unit 381 analyzing the video data and encoding parameter to determine an encoding mode are configured as a separate component. However, an embodiment of the present disclosure is not limited to the above examples. In other words, it may be provided with one functional block into which a function of the converter 371 and a function of the source analysis unit 381 are integrated.

In the above, the exemplary functional configuration of the encoding processor 372 in accordance with an embodiment of the present disclosure has been described with reference to FIG. 6.

### Exemplary Operation of Encoder

An operation of the video encoder 325a in accordance with an embodiment of the present disclosure will now be described in detail. Prior to the description of the operation thereof, the definition of terms to be used for explanation is described.

### DEFINITION OF TERMS

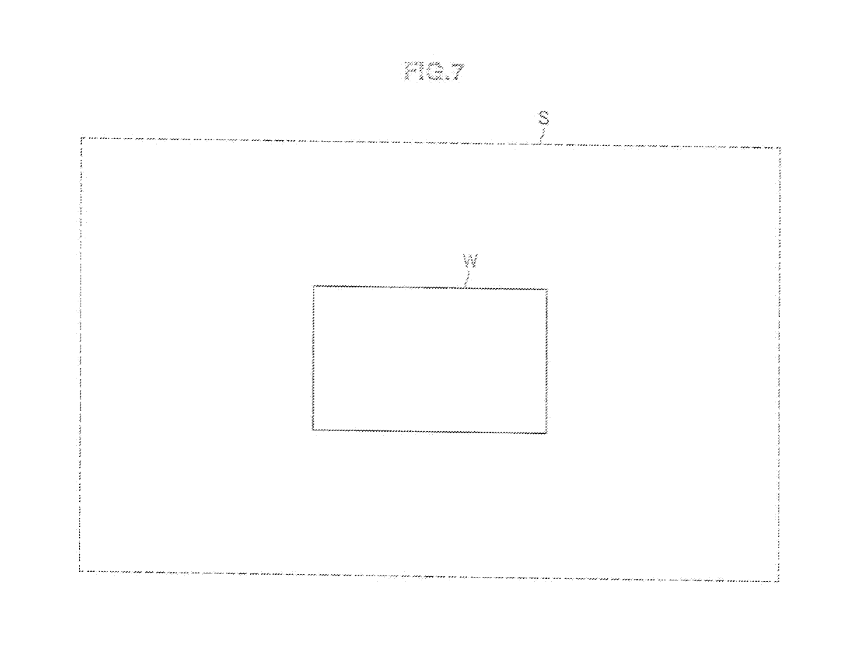

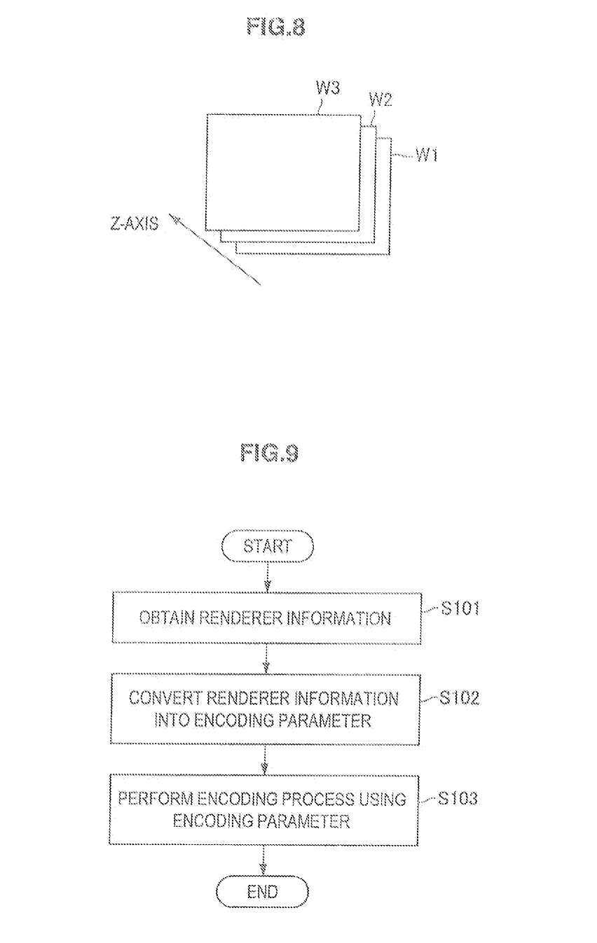

FIGS. 7 and 8 are explanatory diagrams illustrating a definition of terms used for explaining an operation of the video encoder 325a in accordance with an embodiment of the present disclosure. A region S represented by the broken line is referred to as a screen and indicates a range of the area on which video can be displayed in the client 100. The longitudinal and lateral sizes of the screen S are limited and are determined depending on a user profile of the client 100.

A region W represented by the solid line is referred to as a window and indicates an area that is located inside or outside of the screen S. The window W contains detailed information. The renderer 321 generates information to be displayed in the window W. The window W may have a square or rectangular shape. Any number of windows W can be located inside or outside of the screen S. In addition, the window W may be overlapped with one another. FIG. 8 is an explanatory diagram illustrating three windows W1, W2 and W3, which are overlapped in the Z-axis direction (the direction of the front side of the screen S). In the present embodiment, the overlap of the windows is referred to as a layer. When the windows are overlapped, a layer number is assigned to each window. The layer number is assigned to each window so that a window is located in the rear side as its number is lower and a window is located in the front side as its number is higher.

In the following description, a “current frame” refers to a screen at a specific time Tₙ, and a “previous frame” refers to a frame immediately before a current frame, that is, the screen at a specific time Tₙ₋₁.

An encoding mode of the encoding processor 372 in accordance with an embodiment of the present disclosure is defined as follows.

(A) Skip Mode

A skip mode is the mode in which motion estimation (ME), inter mode determination, intra mode determination, and encoding process are omitted. The encoding processor 372 uses this skip mode when there is no change in motion. In addition, the encoding process may include discrete cosine transform (DCT), quantization, and entropy coding.

(B) Inter Mode

An inter mode is the mode in which motion estimation (ME), inter mode determination, and intra mode determination are omitted. The encoding processor 372 uses this inter mode in such a case where an image moves at regular intervals.

(C) Intra Mode

An intra mode is the mode in which motion estimation (ME) and inter mode determination are omitted. The encoding processor 372 uses this intra mode in a new window area or an area appeared abruptly due to a motion or the like.

(D) Vector Search Range Limited Mode

A vector search range limited mode is the mode in which a search range of motion estimation (ME) is narrowed. The encoding processor 372 uses this vector search range limited mode in such a case where an image move at regular intervals or a movement range of an image is narrow.

(E) Normal Mode

A normal mode is the mode in which an encoding process is performed without omitting motion estimation (ME), inter mode determination, intra mode determination, and encoding process.

The source analysis unit 381 analyzes video data by using the video data transmitted from the renderer 321 through the frame buffer 323 and the encoding parameter supplied from the converter 371, and selects a single encoding mode from among the above-described five encoding modes for each frame or for each macro-block in each frame.

The definition of terms used for explaining the operation of the video encoder 325a in accordance with an embodiment of the present disclosure has been described. The operation of the video encoder 325a in accordance with an embodiment of the present disclosure will now be described using the terms defined as described above.

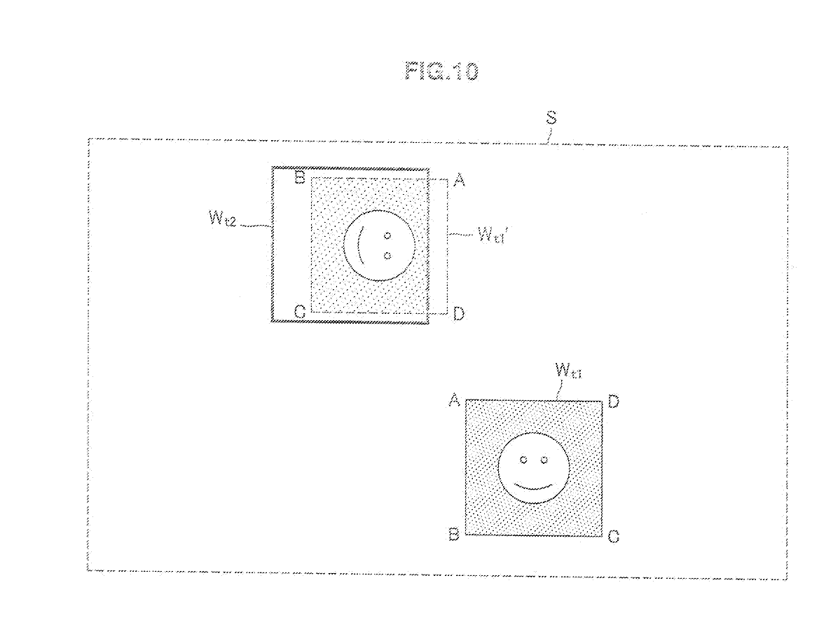

FIG. 9 is a flow chart illustrating an exemplary operation of the video encoder 325a in accordance with an embodiment of the present disclosure. An exemplary operation of the video encoder 325a in accordance with an embodiment of the present disclosure will now be described with reference to FIG. 9.

The video encoder 325a obtains renderer information transmitted from the renderer 321 through the frame buffer 323 (step S101). When the video encoder 325a obtains the renderer information in step S101, the converter 371 of the video encoder 325a converts the renderer information into an encoding parameter (step S102).

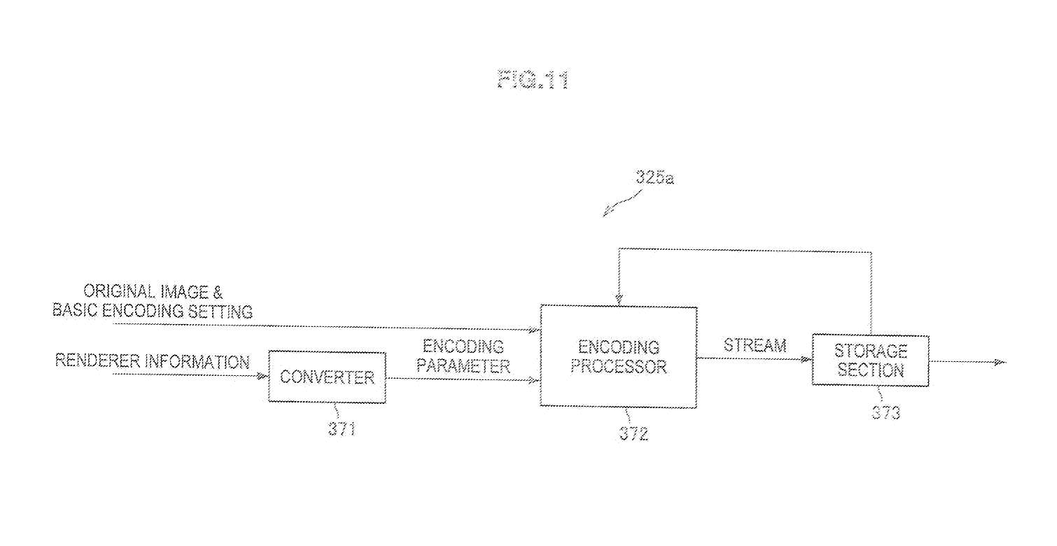

In this regard, the example of data useful for an encoding process in the encoding processor 372 is described again. For this description, FIG. 10 is also used. FIG. 10 is an explanatory diagram used for explaining data useful for an encoding process in the encoding processor 372. An example of data useful for an encoding process in the encoding processor 372 may include, for example, position coordinates of a window Wₜ₂ in the current frame shown in FIG. 10, final position coordinates of a window Wₜ₁′ in the current frame obtained after the window Wₜ₁ of the previous frame is moved (after moving, scaling, or rotating), and a difference indicating how position coordinates of a window of the previous frame is changed to a value in the current frame (that is, the difference between the window Wₜ₁ and the window Wₜ₁′).

In addition to the example described above, an example of data useful for an encoding process in the encoding processor 372 may include transparency for each window, layer information for each window, a flag used in determining whether each window is new or not, a priority level for each window, contents of each window, and a value used in determining whether there is a change in the contents of each window.

The transparency of a window is assumed to be set in the range from 0 to 1. Specifically, if the transparency is 0, then it is transparent. If the transparency is 1, then it is non-transparent. The layer information for each window is the information indicating how much windows are overlapped. For example, if three windows are overlapped as shown in FIG. 8, a layer number for each window is set as the layer information.

In the flag used in determining whether each window is new or not, if a value of the flag is 1, the window having the value is assumed to be appeared newly. Furthermore, the priority level for each window is the information indicating whether a window is to be displayed clean. For example, for a window to be preferentially displayed clean, the encoding processor 372 performs the encoding process by increasing the bit rate to increase the quality of an image.

Moreover, the contents information of each window is the information used for identifying whether the window indicates a still image, whether the window indicates a moving image, whether the window indicates text information, or the like. In addition, the value used in determining whether there is change in the contents of each window is the information indicating, for example, whether there is a change in color when there is no movement, and the information allows the magnitude of change in contents of each window to be determined depending on the magnitude of the value.

Furthermore, the position coordinates of each window is defined by x and y coordinates of the four corners of the window. If a positional relationship between the four corners is defined, it is possible to determine the rotational direction of the window.

The converter 371 converts the data useful for an encoding process into an encoding parameter. For example, it can be determined that an area obtained by subtracting the final position coordinates of the window Wₜ₁′ from the position coordinates of the window Wₜ₂ shown in FIG. 10 is a new area. Thus, in this new area, the converter 371 generates an encoding parameter for allowing the encoding processor 372 to perform the encoding process in the intra mode.

Coordinates of the difference indicating that position coordinates of a window of the previous frame are changed to a value in the current frame (that is, the difference between the window Wₜ₁ and the window W_{t1′}) can be regarded as a motion vector just as it is. Thus, the converter 371 generates motion vector information from the coordinates of the difference.

The combination of the transparency information of a window and the layer information of a window makes it possible to identify the contents of the area in which windows are overlapped. For example, if it is determined that a window is not transparent based on the transparency information of the window, contents of the uppermost layer becomes contents of the window area. In addition, for example, if it is determined that a window is semi-transparent based on the transparency information of the window, whether the uppermost layer may be a still or moving image, the lower layer can be visible, and thus contents of a window for each frame is changed. In other words, if there is a semi-transparent window, the window is regarded as having the same meaning as a moving image.

In a case of a window having a flag used to determine whether the window is new or not, it means that the window is a new area. Thus, there is no point in calculating motion estimation (ME) by the encoding processor 372. Therefore, the converter 371 generates an encoding parameter for allowing the encoding processor 372 to perform the encoding process in the intra mode for the window having the flag used to determine whether the window is new or not.

If the priority level of a window has a large value, this means that the window area is necessary to be protected. Thus, the converter 371 generates an encoding parameter for allowing the window area to be allocated with a higher bit rate by the rate control of the encoding processor 372.

The contents of content displayed on each window can be recognized using a value of information of contents for each window. If there is a window for displaying text information, the text information becomes easily noticeable visually. Thus, the converter 371 generates an encoding parameter for allowing the window area to be allocated with a higher bit rate by the rate control of the encoding processor 372.

If the value used in determining whether there is a change in the contents of each window is small, the window having the value is substantially unchanged. Thus, this means that the window is regarded as having the same meaning as a still image. If the value used in determining whether there is a change in the contents of each window is large, the window is regarded as having the same meaning as a moving image. Therefore, the converter 371 can set an appropriate encoding mode for a target window according to the value used in determining whether there is a change in the contents of each window.

Note that, the above-described process is only an illustrative example, and the converter 371 can set an appropriate encoding mode, quantization value, vector value, or the like from different perspectives, in addition to the above-described examples.

In the above-described step S102, if the converter 371 converts the renderer information into an encoding parameter, then the encoding processor 372 performs an encoding process on the moving image data supplied from the renderer 321 according to the encoding parameter generated by the converter 371 (step S103). Upon encoding the moving image data, the encoding processor 372 causes the source analysis unit 381 to analyze the encoding parameter, and determines which process can be skipped.

As an example, when an encoding mode is set to be the skip mode by the converter 371, a copy of the previous frame may be basically used when the current frame is encoded because the encoding mode is the mode that is selected when there is no motion. Accordingly, the encoding processor 372 may not perform motion estimation (ME), inter mode determination, intra mode determination, and coding process of the encoding process, thereby achieving a significant reduction in computational complexity upon encoding. In addition, because the encoding processor 372 can skip a coding process in the skip mode, it is possible to reduce the amount of packets to be transmitted to the client 100.

As another example, when an encoding mode is set to be the inter mode by the converter 371, the encoding processor 372 may not perform motion estimation (ME), inter mode determination, and intra mode determination of the encoding process, thereby achieving a significant reduction in computational complexity upon encoding.

As another example, when an encoding mode is set to be the intra mode by the converter 371, because this mode is selected in an area that is newly appeared, there is no area to be referred even when there is the previous frame. Accordingly, the encoding processor 372 may not perform motion estimation (ME), and an inter mode determination of the encoding process, thereby achieving a significant reduction in computational complexity upon encoding.

As another example, when an encoding mode is set to be the vector search range limited mode by the converter 371, the encoding processor 372 can omit or simplify the calculated amount of computation of the motion vector upon searching the motion vector by using a motion vector obtained from the difference coordinates of the window position, thereby achieving a reduction in computational complexity upon encoding.

As another example, when there is a window that is set to have a high priority level, the encoding processor 372 can previously recognize an area where a user is particularly concerned with the quality of image. This recognized area allows the source analysis unit 381 to allocate a more bit to the area. Thus, the encoding processor 372 allows an encoding process to be performed considering the user's intention.

As another example, when there is a window in which the contents of content are text, the text is easily noticeable visually. Thus, the encoding processor 372 allows the window to be allocated with a higher bit rate by the rate control of the source analysis unit 381.

The encoding processor 372 performs an encoding process based on an analysis result obtained by analyzing an encoding parameter in the source analysis unit 381.

The encoding process to be performed by the encoding processor 372 is not limited to the above examples. For example, by placing a limit on the application provided from the server 300 in order for the user's operation speed to become constant, the motion vectors have the same values, thereby improving the coding efficiency of the encoding processor 372. In addition, for example, by placing a limit on the application provided from the server 300 in order for content not to straddle the boundary of a macro block, it is possible to unify the encoding modes in the macro black, thereby improving the coding efficiency of the encoding processor 372.

As another example, the encoding processor 372 can implement more optimal bit rate allocation by previously recognizing information of a subsequent image using an encoding parameter. For example, if the renderer 321 transmits information of the subsequent image indicating that an operation for enlarging an image is completed after two seconds and then stands still to the encoding processor 372, the encoding processor 372 can perform optimal bit rate allocation during a time from when an image is enlarged to when the enlargement ends, thereby achieving the uniform image quality change upon standing still.

An exemplary operation of the video encoder 325a in accordance with an embodiment of the present disclosure has been described with reference to FIG. 9. By performing the operation as described above, the video encoder 325a in accordance with an embodiment of the present disclosure allows the processing load to be mitigated for the video to be encoded and allows the amount of packets to be reduced.

In an encoder according to the related art, an image is quantized and the quantized image is subject to inverse quantization or inverse discrete cosine transformation, and then the image is returned to an original frame image. In this case, the motion detection is performed between the original frame image and the subsequent frame image. Depending on a result of the motion detection, the determination whether the image is a still or moving image, or the motion compensation is performed. Consequently, in the encoder according to the related art, an excessive load is applied on the process such as motion detection or motion compensation.

On the contrary, the video encoder 325a in accordance with an embodiment of the present disclosure can previously obtain information indicating what types of content are supplied from the renderer 321, how video is changed, or the like. Thus, in accordance with an embodiment of the present disclosure, the video encoder 325a using this information can skip a quantization process or coding process as necessary, as well as inverse quantization or inverse discrete cosine transformation, thereby achieving a significant reduction in processing load.

### Modified Example

A modified example of the video encoder 325a in accordance with an embodiment of the present disclosure will now be described. In the streaming system in accordance with an embodiment of the present disclosure described above, a plurality of clients 100 receive content distributed from the servicer 210. The same content may be distributed to different clients 100 from the servicer 210. The user's operation of the client 100 may be limited to some extent depending on content. An example of such content includes a menu screen.

Therefore, the server side obtains statistics of similar user's operations, and the video encoder 325a encodes an operation of a higher level statistically. A stream obtained by encoding the operation is previously cached. There is no benefit to the user who has first performed the operation, but thereafter, a user who receives content by performing the same operation as the first operation can easily obtain content only by an operation of joining the streams held on the server side. Thus, it is possible to achieve a reduction in computational complexity of the encoding itself.

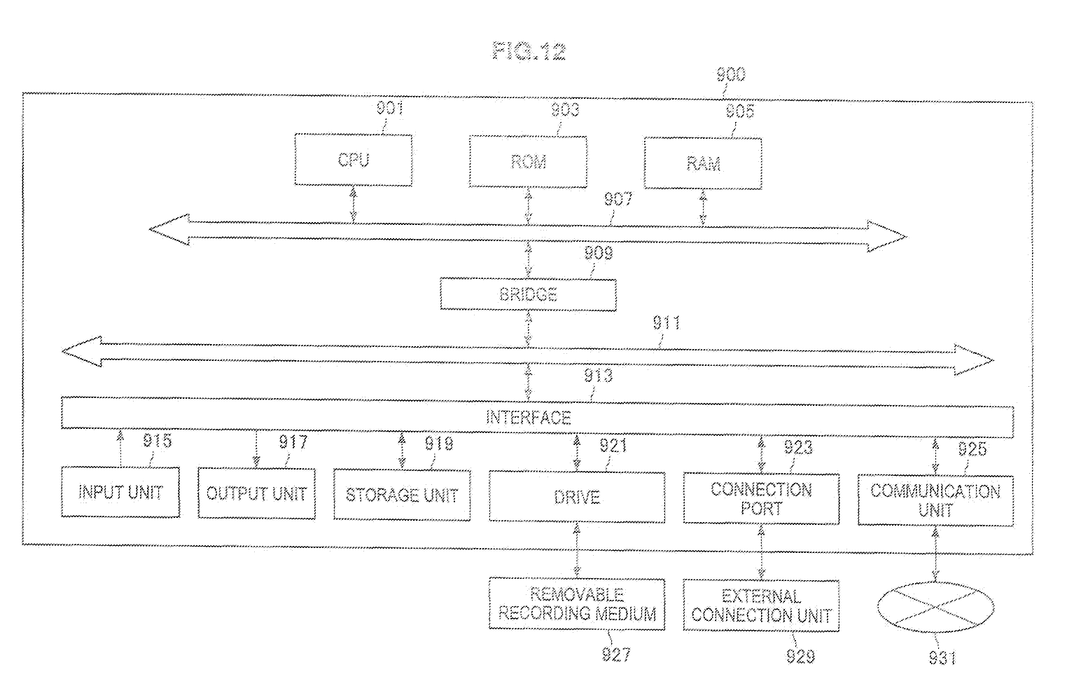

FIG. 11 is an explanatory diagram illustrating a modified example of the video encoder 325a in accordance with an embodiment of the present disclosure. In a configuration shown in FIG. 11, a storage section 373 is added to the video encoder 325a shown in FIG. 5. The storage section 373 is configured to cache the stream outputted from the encoding processor 372. The stream that is cached in the storage section 373 is the stream corresponding to a user's operation that is ranked at a higher level statistically.

In accordance with an embodiment of the present disclosure, when the video encoder 325a receives a fact that the user's operation ranked at a higher level statistically is performed from the player controller 340 or the like, the video encoder 325a performs an operation for causing the storage section 373 to output the cached stream. This makes it possible to achieve a reduction in computational complexity of the encoding itself.

Furthermore, content to be distributed from the server 300 are previously assigned with a unique ID, and information regarding a timing of receiving the same ID repeatedly or the ID itself is recognized. This makes it possible for the video encoder 325a to skip an encoding process for the content having the same ID. In other words, at first, the video encoder 325a performs an encoding process and causes the storage section 373 to cache the stream as usual. Thereafter, when the video encoder 325a receives content having the same ID as that supplied previously, the video encoder 325a joins and outputs the streams cached in the storage section 373. This makes is possible for the video encoder 325a to achieve a reduction in computational complexity of the encoding itself.

In addition, the video encoder 325a may cache data that is a state before encoding in the storage section 373 instead of caching the stream itself.

An exemplary hardware configuration of the server 300 in accordance with an embodiment of the present disclosure will now be described. FIG. 12 is an explanatory diagram illustrating an exemplary hardware configuration of an information processing apparatus 900. The information processing apparatus 900 is an example of the server 300 in accordance with an embodiment of the present disclosure.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input unit 915, an output unit 917, a storage unit 919, a drive 921, a connection port 923, and a communication unit 925. Further, the information processing apparatus 900 may include an imaging unit 933 and a sensor 935 as necessary. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage unit 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input unit 915 may be a device which is operated by a user, such as a mouse, a keyboard, a touch panel, buttons, switches and a lever. The input unit 915 may be, for example, a remote control unit using infrared light or other radio waves, or may be an external connection unit 929 such as a portable phone operable in response to the operation of the information processing apparatus 900. Furthermore, the input unit 915 includes an input control circuit which generates an input signal on the basis of the information which is input by a user and outputs the input signal to the CPU 901. By operating the input unit 915, a user can input various types of data to the information processing apparatus 900 or issue instructions for causing the information processing apparatus 900 to perform a processing operation.

The output unit 917 includes a device capable of visually or audibly notifying the user of acquired information. The output unit 917 may include a display device such as LCD (Liquid Crystal Display). PDP (Plasma Display Panel), and organic EL (Electro-Luminescence) displays, an audio output device such as speaker and headphone, and a peripheral device such as printer. The output unit 917 may output the results obtained from the process of the information processing apparatus 900 in a form of a video such as text or image, and an audio such as voice or sound.

The storage unit 919 is a device for data storage which is configured as an example of a storage unit of the information processing apparatus 900. The storage unit 919 includes, for example, a magnetic storage device such as HDD (Hard Disk Drive), a semiconductor storage device, an optical storage device, or a magneto-optical storage device. The storage unit 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection unit 929 to the connection port 923 makes it possible to exchange various data between the information processing apparatus 900 and the external connection unit 929.

The communication unit 925 is, for example, a communication interface including a communication device or the like for connection to a communication network 931. The communication unit 925 may be, for example, a communication card for a wired or wireless LAN (Local Area Network), Bluetooth (registered trademark), WUSB (Wireless USB) or the like. In addition, the communication unit 925 may be a router for optical communication, a router for ADSL (Asymmetric Digital Subscriber Line), a modem for various kinds of communications, or the like. The communication unit 925 can transmit and receive signals to and from, for example, the Internet or other communication devices based on a predetermined protocol such as TCP/IP. In addition, the communication network 931 connected to the communication unit 925 may be a network or the like connected in a wired or wireless manner, and may be, for example, the Internet, a home LAN, infrared communication, radio wave communication, satellite communication, or the like.

The foregoing thus illustrates an exemplary hardware configuration of the information processing apparatus 900. Each of the above components may be realized using general-purpose members, but may also be realized in hardware specialized in the function of each component. Such a configuration may also be modified as appropriate according to the technological level at the time of the implementation.

### 2. CONCLUSION

As described above, in accordance with an embodiment of the present disclosure, there is provided with the video encoder 325a which converts data useful for an encoding process into an encoding parameter by performing the encoding process and optimizes the encoding process using the data before the video encoder 325a performs the encoding process on renderer information outputted from the renderer 321. The video encoder 325a refers to the encoding parameter, and then omits the encoding process if there is an encoding process that can be omitted.

With this configuration, the video encoder 325a can skip a quantization process or coding process as necessary, as well as inverse quantization or inverse discrete cosine transformation, thereby achieving a significant reduction in processing load. In addition, the use of the video encoder 325a makes it possible to reduce throughput of the encoding process without degrading the quality of content. Additionally, when content is distributed from the server to the client, the use of the video encoder 325a makes it possible to simultaneously achieve low latency, low cost, improvement of robustness for fluctuation in a network bandwidth, and retention of image quality acceptable to a service, thereby reducing load on the server and maintaining a high quality of service.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing device including:

a converter configured to obtain, prior to performing an encoding process, image drawing information of an image capable of using upon encoding and to convert the obtained image drawing information into a parameter for encoding; and

an encoding processor configured to perform the encoding process by changing contents of the encoding process according to the parameter for encoding converted by the converter.

(2) The image processing device according to (1), wherein the converter converts an amount of movement of an image drawing area for each frame into information regarding a motion vector.
(3) The image processing device according to (1) or (2), wherein the converter converts contents of an image drawn in an image drawing area for each frame into information regarding a bit rate.
(4) The image processing device according to any one of (1) to (3), wherein the image drawing information obtained by the converter includes coordinates of an image drawing area for each frame.
(5) The image processing device according to any one of (1) to (4), wherein the image drawing information obtained by the converter includes coordinates after movement of an image drawing area for each frame.
(6) The image processing device according to any one of (1) to (5), wherein the image drawing information obtained by the converter includes a difference between image drawing areas for each frame.
(7) The image processing device according to any one of (1) to (6), wherein the image drawing information obtained by the converter includes priority information of an image drawing area for each frame.
(8) The image processing device according to any one of (1) to (7), wherein the image drawing information obtained by the converter includes information regarding a presence or absence of a change in an image drawn in an image drawing area for each frame.
(9) The image processing device according to any one of (1) to (8), wherein the encoding processor performs the encoding process by skipping a part of the encoding process based on the parameter for encoding converted by the converter.
(10) The image processing device according to any one of (1) to (9), further including:

a storage section configured to store data encoded by the encoding processor,

wherein the encoding processor, when an image to be encoded is encoded and stored in the storage section, causes the storage section to output data without performing the encoding process on the image.
(11) The image processing device according to any one of (1) to (10), further including:

a storage section configured to store data encoded by the encoding processor according to contents of a user operation of causing the encoding process by the encoding processor and according to the user operation whose execution count is greater than a predetermined value,

wherein the encoding processor, when a user operation stored in the storage section is performed, if data being encoded according to the user operation is stored in the storage section, causes the storage section to output the data without performing the encoding process.

(12) An image processing method including:

obtaining, prior to performing an encoding process, image drawing information of an image capable of using upon encoding and converting the obtained image drawing information into a parameter for encoding; and

performing the encoding process by changing contents of the encoding process according to the parameter for encoding converted in the step of converting.

(13) An image processing system including:

a server device configured to encode an image and distribute the encoded image over a network; and

a terminal device configured to display the image distributed from the server device,

wherein the server device includes,

a converter configured to obtain, prior to performing an encoding process, image drawing information of an image capable of using upon encoding and to convert the obtained image drawing information into a parameter for encoding, and

an encoding processor configured to perform the encoding process by changing contents of the encoding process according to the parameter for encoding converted by the converter.

The present disclosure contains subject matter related to that disclosed in Japanese Priority Patent Application JP 2012-223048 filed in the Japan Patent Office on Oct. 5, 2012, the entire contents of which is hereby incorporated by reference.

What is claimed is:

1. An image processing device comprising:
a converter configured to obtain, prior to performing an encoding process, image drawing information of an image capable of using upon encoding and to convert the obtained image drawing information into a parameter for encoding; and
an encoding processor configured to perform the encoding process by changing contents of the encoding process according to the parameter for encoding converted by the converter.

2. The image processing device according to claim 1, wherein the converter converts an amount of movement of an image drawing area for each frame into information regarding a motion vector.

3. The image processing device according to claim 1, wherein the converter converts contents of an image drawn in an image drawing area for each frame into information regarding a bit rate.

4. The image processing device according to claim 1, wherein the image drawing information obtained by the converter includes coordinates of an image drawing area for each frame.

5. The image processing device according to claim 1, wherein the image drawing information obtained by the converter includes coordinates after movement of an image drawing area for each frame.

6. The image processing device according to claim 1, wherein the image drawing information obtained by the converter includes a difference between image drawing areas for each frame.

7. The image processing device according to claim 1, wherein the image drawing information obtained by the converter includes priority information of an image drawing area for each frame.

8. The image processing device according to claim 1, wherein the image drawing information obtained by the converter includes information regarding a presence or absence of a change in an image drawn in an image drawing area for each frame.

9. The image processing device according to claim 1, wherein the encoding processor performs the encoding process by skipping a part of the encoding process based on the parameter for encoding converted by the converter.

10. The image processing device according to claim 1, further comprising:
a storage section configured to store data encoded by the encoding processor,
wherein the encoding processor, when an image to be encoded is encoded and stored in the storage section, causes the storage section to output data without performing the encoding process on the image.

11. The image processing device according to claim 1, further comprising:
a storage section configured to store data encoded by the encoding processor according to contents of a user operation of causing the encoding process by the encoding processor and according to the user operation whose execution count is greater than a predetermined value,
wherein the encoding processor, when a user operation stored in the storage section is performed, if data being encoded according to the user operation is stored in the storage section, causes the storage section to output the data without performing the encoding process.

12. An image processing method comprising:
obtaining, prior to performing an encoding process, image drawing information of an image capable of using upon encoding and converting the obtained image drawing information into a parameter for encoding; and
performing the encoding process by changing contents of the encoding process according to the parameter for encoding converted in the step of converting.

13. An image processing system comprising:
a server device configured to encode an image and distribute the encoded image over a network; and
a terminal device configured to display the image distributed from the server device,
wherein the server device includes,
a converter configured to obtain, prior to performing an encoding process, image drawing information of an image capable of using upon encoding and to convert the obtained image drawing information into a parameter for encoding, and
an encoding processor configured to perform the encoding process by changing contents of the encoding process according to the parameter for encoding converted by the converter.
